(19) United States
(12) Patent Application Publication
(10) Pub. No.: US 2014/0172453 A1
(43) Pub. Date: Jun. 19, 2014

(54) SEPARATING STORAGE OF PERSONAL FROM NON-PERSONAL HEALTH INFORMATION

(71) Applicant: REDBRICK HEALTH CORPORATION, Minneapolis, MN (US)

(72) Inventor: Gal Bar-or, Wilson, WY (US)

(73) Assignee: RedBrick Health Corporation, Minneapolis, MN (US)

(21) Appl. No.: 13/720,049

(22) Filed: Dec. 19, 2012

(51) Int. Cl. G06F 19/00; G06Q 50/24

(52) U.S. Cl. CPC G06F 19/322; G06Q 50/24
USPC 705/3

(57) ABSTRACT

Separating storage of personal from non-personal health information. At a server device, receiving and responding to requests from an application that involve access to both personal and non-personal health information. Parsing those requests into first portions which do not involve access to personal health information, and second portions which do. Referring those portions which involve access to personal health information to an information agent, which uses configuration information to determine how to access that personal health information. Separately accessing the personal health information using a secure key and referring an answer to those portions which involve access to both personal health information to the server device. At the server device, composing a response to requests from the application, including responses to both those first portions and those second portions.

### BACKGROUND

1. Field of the Disclosure

This application generally relates to separating storage of personal from non-personal health information.

2. Background of the Disclosure

Healthcare management systems operate in part by receiving information with respect to patients and other users, such as individuals designed to improve their health, or engaging in a plan a program of health improvement. For a first example, healthcare management systems might maintain information with respect to nutrition or exercise of a user or patient, and might compare that information with a plan or program of health improvement to be followed by the user or patient. For a second example, healthcare management systems might record that information with respect to nutrition and exercise of a user or patient, and compare that information with parameters for nutrition and exercise which are recommended by medical or other health-related authorities.

It sometimes occurs that users or patients might desire to access personal information about themselves, while using a software element on a mobile device or other computer system, such as recording nutrition or exercise information with respect to themselves, or such as accessing healthcare management functions about information with respect to themselves. In such cases, it is often desirable to maintain security requirements, such as authentication and communication security, with respect to that information about the user or patient.

It sometimes occurs that healthcare management functions can be performed by computer processing elements and computer storage elements which are maintained “in the cloud”, that is, at facilities which are dynamically allocated and are not necessarily within the control of the healthcare management system performing those functions. For example, facilities “in the cloud” might include hardware devices (A) not under the administrative control or physical control of the healthcare management system, (B) not owned, leased, or operated by the healthcare management system, or (C) otherwise subject to access or manipulation by entities or persons other than the healthcare management system. Similarly, it sometimes occurs that healthcare management information can be manipulated by computer processing elements and maintained on computer storage elements which are also maintained “in the cloud”, that is, at facilities which are dynamically allocated and are not necessarily within the control of the healthcare management system performing those functions.

Both performing those functions or maintaining that information “in the cloud” can be significantly more convenient than using hardware devices under the administrative control and physical control of the healthcare management system. Personal information about users or patients, or other information useful in the context of healthcare management functions, is more easily maintained “in the cloud”, at least in part because of the flexibility of dynamic allocation and the relatively reduced expense of maintaining overhead in the form of computer processing elements and computer storage elements.

While performing those functions or maintaining that information “in the cloud” can be significantly more convenient, there can be drawbacks to performing those functions or maintaining that information “in the cloud”. For a first example, there are security considerations with respect to those functions and that information that might be insufficiently addressed by performing those functions or maintaining that information “in the cloud”. For a second example, there are regulatory considerations with respect to that information that might be insufficiently addressed by maintaining that information “in the cloud”.

Each of these examples, as well as other possible considerations, can cause difficulty in aspects of a healthcare management system, particularly in those cases in which a user or patient desires to use aspects of a healthcare management system while using a software element on a mobile device or other computer system. Similarly, each of these examples, as well as a possible considerations, can cause difficulty in aspects of the healthcare management system, particularly in those cases in which there is an advantage to maintaining the flexibility of dynamic allocation and the relatively reduced expense of maintaining overhead in the form of computer processing elements and computer storage elements. For example, lack of flexibility might have a detrimental effect on the value of the healthcare management system to the user or patient, or otherwise.

### BRIEF SUMMARY OF THE DISCLOSURE

This application provides techniques that separate storage of personal from non-personal health information, including without limitation, maintaining and communicating data in association with an application.

In one embodiment, the application communicates with and accesses an identification element, which can authenticate the application, or a user associated with that application, and can allow the application or user to perform operations with respect to the user's data. In those cases in which the data is not secure information, such as non-personal health information, the identification element can communicate with a database in which the non-secure information is maintained, such as maintained on a cloud-based storage service.

In one embodiment, in those cases in which the data is secure information, such as personal health information (or other information desired to be maintained securely), the identification element can communicate with a secure hosting element, which can maintain the secure information and release it only when the identification element is able to provide sufficiently secure authentication to access that secure information. In one embodiment, the identification element maintains a secure key to show its secure authentication.

In one embodiment, the secure hosting element maintains the secure information in one or more formats, each of which can be associated with an information agent, which can communicate with the identification element and provide the secure information to in response to one or more requests. A set of configuration information includes sufficient information for each such information agent. A secure database includes the secure information, in one or more formats which can be created, read, updated, or deleted (CRUD) in the secure database.

After reading this application, those skilled in the art would recognize that techniques shown in this application are applicable to fields and information other than healthcare management systems. In the context of the invention, there is no particular requirement for any such limitation. Moreover, after reading this application, those skilled in the art would recognize that techniques shown in this application are applicable to methods and systems other than those involving data entry or by individuals. For example, other healthcare contexts can include frequent or important entry of data, such as related to improvement of sleep, stress and resiliency management, cessation of negative behaviors (such as tobacco use, excessive alcohol use, and otherwise), self care of other health considerations (such as back strain or back pain, diabetes or pre-diabetic condition management, weight loss, and otherwise), and training for athletic events. Similarly, non-healthcare contexts can include frequent or important entry of data, such as related to customer service, marketing and sales, and otherwise.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

FIG. 1 shows a conceptual drawing of an example system including separation of storage of personal from non-personal health information.

FIG. 2 shows a conceptual drawing of a method of using an example system.

FIG. 3 shows a conceptual drawing of a protocol for accessing a secure information database.

FIG. 4 shows a conceptual drawing of information flow in an example system.

### DETAILED DESCRIPTION

### Example System Elements

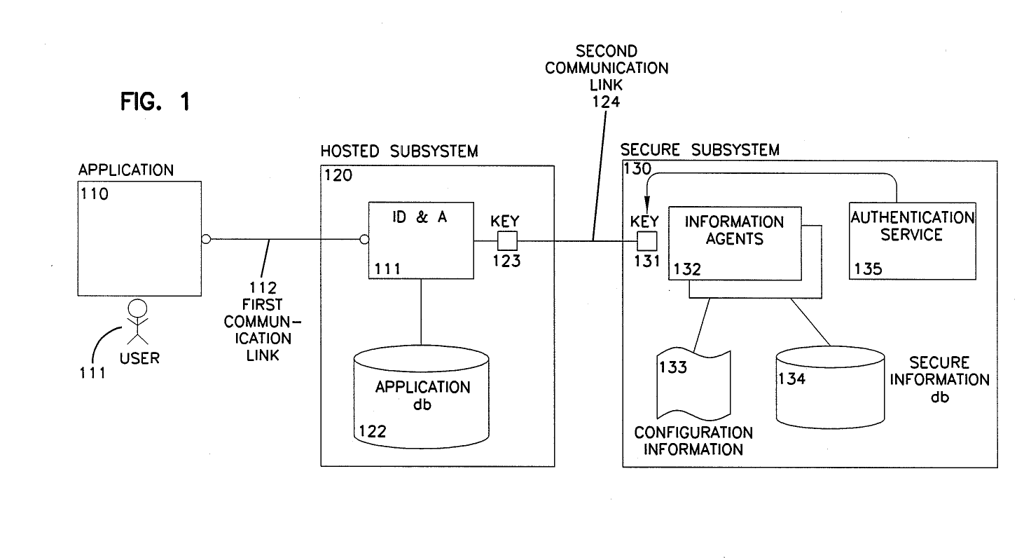

FIG. 1 shows a conceptual drawing of an example system including separation of storage of personal from non-personal health information.

An example system includes an application 110, a hosted subsystem 120, and a secure subsystem 130.

Elements of the system are described herein with respect to one or more possible embodiments, and are not intended to be limiting in any way. In the context of the invention, there is the particular requirement for any such limitations as described with respect to any elements of the system. For example, individual elements of the system 100 could be replaced with substitutes which perform similar functions. Moreover, as described herein, many individual elements of the system are optional, and are not required for operation.

Although one or more elements of the system are described herein as being executed as if on a single computing device, in the context of the invention, there is no particular requirement for any such limitation. For example, the one or more computing devices can include a cluster of devices, not necessarily all similar, on which the element's functions are performed, such as a cloud computing execution platform or cluster computing platform. Also, while this application generally describes one or more elements of the system as distinct, in the context of the invention, there is no particular requirement for any such limitation. For example, the one or more elements of the system could include common elements, or could even be substantially the same devices, such as one or more such devices performing the functions of distinct elements as separate processes or threads.

APPLICATION. The application 110 includes a hardware element, including a computing device, and a software element, including instructions executable or interpretable by the computing device to perform functions as described herein. In general, unless otherwise described herein, devices which perform functions can be embodied in hardware elements and software elements which are collectively disposed to implement those functions, or can be embodied as hardware elements which are disposed to implement those functions with or without software, or can be embodied as software elements which are disposed to be executed or interpreted by general-purpose devices emulating hardware elements for which those software elements are otherwise designed. For a first example, hardware elements and software elements can include a processor, memory and storage, operating system software and application program software. For a second example, devices can include hardware elements and software elements can include a processor, memory and storage, virtual machine software emulating a hardware device, and further software elements disposed to be executed or interpreted by that virtual machine.

In one embodiment, the application 110 is disposed to be accessed or controlled by a user 111, such as a human being (or a program operating under the control of one or more human beings). The application 110 is also disposed to be coupled to the hosted subsystem 120 using a first communication link 111, such as a secure communication link. For a first example, the first communication link 111 can include a secure sockets layer (SSL) communication system, such as in use with the Internet. For a second example, the first communication link 111 can include an otherwise encrypted communication link, such as using a public-key cryptosystem, or otherwise.

In one embodiment, for example, the application 110 includes a mobile device which is disposed for being carried by the user 111, and can include a smart phone or similar mobile device.

HOSTED SUBSYSTEM. The hosted subsystem 120 includes a hardware element, including a computing device, and a software element, including instructions executable or interpretable by the computing device to perform functions as described herein. In general, unless otherwise described herein, devices which perform functions can be embodied in hardware elements and software elements which are collectively disposed to implement those functions, or can be embodied as hardware elements which are disposed to implement those functions with or without software, or can be embodied as software elements which are disposed to be executed or interpreted by general-purpose devices emulating hardware elements for which those software elements are otherwise designed. For a first example, hardware elements and software elements can include a processor, memory and storage, operating system software and application program software. For a second example, devices can include hardware elements and software elements can include a processor, memory and storage, virtual machine software emulating a hardware device, and further software elements disposed to be executed or interpreted by that virtual machine.

In one embodiment, the hosted subsystem 120 includes an identification and access management (ID&A) element 121 and an application database 122. The ID&A element 121 is coupled to the application 110 using the first communication link 111. The ID&A element 121 is also coupled to the application database 122, and is disposed to maintain information in the application database 122, such as by performing create, read, update, and delete (CRUD) operations.

In one embodiment, the ID&A element 121 is disposed for execution or interpretation by a cloud-hosted computing system, such as the Amazon elastic compute cloud (EC2) system, and maintains its data and other information using cloud-hosted storage, such as the Amazon simple storage service (S3) system. Similarly, in one embodiment, the application database 122 is disposed for execution or interpretation by a cloud-hosted computing system, where execution or interpretation are required, such as for database operations, and is disposed to maintain its data and other information using cloud-hosted storage.

For example, as described herein, the application database 122 can include a majority of data maintained on behalf of the user 111. For example, the application database 122 can include all data maintained on behalf of the user 111 which is not required to be maintained in secure storage, whether for engineering reasons, legal reasons such as HIPAA requirements or similar requirements, security requirements such as maintaining trade secrets or similar requirements, or otherwise.

In one embodiment, the ID&A element 121 maintains a key 123, which is disposed to allow the ID&A element 121 to access the application database 122, such as database tables, records, or fields, in the application database 122. The key 123 is also disposed to allow the ID&A element 121 to access and be accessed by the secure subsystem 130. The key 123 is maintained secure against copying, spoofing, or other security attacks, such as by encrypting the key 123 and allowing access to the key 123 only by the ID&A element 121 when the latter presents adequate authentication. Although in one embodiment, the same key 123 is used by the ID&A element 121 both to access the application database 122 and to access and be accessed by the secure subsystem 130, in the context of the invention, there is no particular requirement for any such limitation. For example, more than one such key can be used.

The ID&A element 121 is coupled to the secure subsystem 130 using the key 123 and using a second communication link 124, such as a secure communication link. For a first example, the second communication link 124 can include a secure sockets layer (SSL) communication system, such as in use with the Internet. For a second example, the second communication link 124 can include an otherwise encrypted communication link, such as using a public-key cryptosystem, or otherwise.

SECURE SUBSYSTEM. The secure subsystem 130 includes a hardware element, including a computing device, and a software element, including instructions executable or interpretable by the computing device to perform functions as described herein. In general, unless otherwise described herein, devices which perform functions can be embodied in hardware elements and software elements which are collectively disposed to implement those functions, or can be embodied as hardware elements which are disposed to implement those functions with or without software, or can be embodied as software elements which are disposed to be executed or interpreted by general-purpose devices emulating hardware elements for which those software elements are otherwise designed. For a first example, hardware elements and software elements can include a processor, memory and storage, operating system software and application program software. For a second example, devices can include hardware elements and software elements can include a processor, memory and storage, virtual machine software emulating a hardware device, and further software elements disposed to be executed or interpreted by that virtual machine.

In one embodiment, the secure subsystem 130 includes a key 131, one or more information agents 132, a set of configuration information 133, and one or more secure information databases 134.

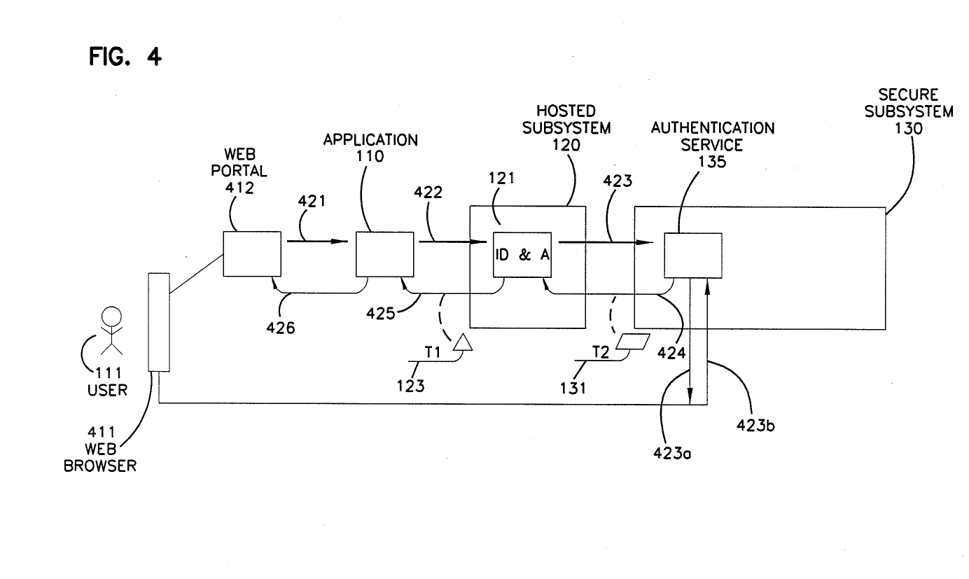

In one embodiment, the secure subsystem 130 and the key 131 are disposed to allow the secure subsystem 130 to access and be accessed by the ID&A element 121. In one embodiment, the key 123 and the key 131 are associated with each other, such as might occur if they are identical (in a symmetric key cryptosystem) or if they are corresponding keys in a public-key cryptosystem, or such as described with respect to the FIG. 4. For example, the key 123 and the key 131 might correspond in a secure sockets layer (SSL) secure communication link, such as the second communication link 124 might include. In one embodiment, the key 123 and the key 131 correspond to tokens “T1” and “T2”, as described with respect to the FIG. 4, by which the ID&A element 121 and the secure subsystem 130 can communicate.

In one embodiment, the one or more information agents 132 access the configuration information 133, with the effect that each one of the information agents 132 can access and maintain information in one or more of the secure information databases 134. For example, one or more of the secure information databases 134 might include a flat text database, a lightweight directory access protocol (LDAP) database, an Oracle database, a “PeopleSoft” database, an HR database product, some combination or conjunction thereof, or otherwise. This has the effect that the one or more secure information databases 134 can include secure information in more than one database format, more than one information format, or some combination or conjunction thereof. For example, a first portion of the secure information can be accessed and maintained in a first information format or a first database protocol, while a second portion of the secure information can be accessed and maintained in a second information format or a second database protocol.

In one embodiment, the one or more information agents 132 each accepts requests from the ID&A element 121, such as in the format [name of field], and provides responses to the ID&A element 121, such as in the format [name of field, method of access]. This has the effect that the ID&A element 121 need not have any substantial information with respect to how he secure information is maintained in a secure information databases 134. This in turn has the effect that the secure information databases 134 can maintain their secure information using one or more techniques with respect to which the secure information is relatively difficult to obtain without access to the configuration information 133 and assistance of one or more of the information agents 132.

MULTIPLE SECURE INFORMATION DATABASES. Although the secure subsystem 130 is described in this application primarily with respect to individual accesses to each secure information database 134, in some embodiments, it is possible for secure information to be maintained on more than one secure information database 134 concurrently.

In a first embodiment, a first secure information database 134 can maintain a first portion of secure information with respect to an individual, while a second secure information database 134 can maintain a second portion of secure information with respect to that individual. In such embodiments, distinct secure information is separately maintained with respect to that individual. This has the effect that loss of either the first secure information database 134 or the second secure information database 134 does not result in a complete loss of information about that individual.

In a second embodiment, a first secure info nation database 134 can maintain at least some secure information with respect to an individual, while a second secure information database 134 can maintain in replicated form, in whole or in part, at least some of the same secure information with respect to that same individual. In such embodiments, the first secure information database 134 and the second secure information database 134 can serve as backup repositories for each other. If either the first secure information database 134 or the second secure information database 134 should fail, or even merely become inaccessible for a time duration, the remaining secure information database 134 can respond to requests for the secure information about that individual.

The first embodiment just described and the second embodiment just described can be combined. For example, distinct portions of secure information about the individual can be separately maintained, with redundant information also maintained, similar to a RAID storage system. This has the effect that loss of either the first secure information database 134 or the second secure information database 134 allows the system 100 to recover secure information about the individual, similar to reconstructing information in a RAID storage system.

If more than one secure information database 134 maintains secure information about an individual, the secure subsystem 130 can maintain (A) a single key 131 for all those secure information databases 134, (B) one such key 131 for each such secure information database 134, or (C) a single key 131 for some secure information or some individuals and more than one such key 131 for other secure information or other individuals. Similarly, the secure subsystem 130 can maintain similar information agents 132 and configuration information 133 for all those secure information databases 134, more than one such information agent 132 configuration information 133 for each, or otherwise.

In one embodiment, if the ID&A element 121 requests action by more than one secure information database 134, each such secure information database 134 performs its operation concurrently and returns its response to the ID&A element 121. The ID&A element 121 combines the responses from the secure information databases 134, and constructs a single response to make to the request made by the application 110. In some cases, the ID&A element 121 receives the responses from the secure information databases 134, determines that it should make further requests from one or more of the secure information databases 134, and does so. This has the effect that, if secure information about the individual involves multiple or serial requests to the secure information databases 134, the ID&A element 121 can make those requests, obtain responses, and repeat that process, until all needed information has been obtained, or all needed CRUD operations have been performed. When all needed information has been obtained, or all needed CRUD operations have been performed, the ID&A element 121 makes a single response to the application 110. This has the effect that the application 110 cannot determine whether the secure information is maintained in more than one such secure information database 134.

Method of Operation

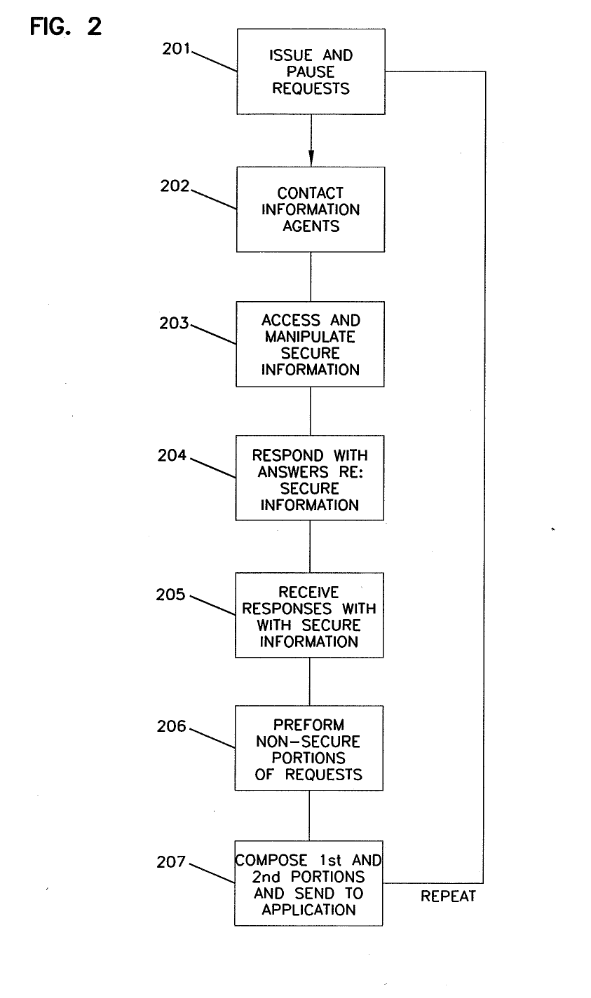

FIG. 2 shows a conceptual drawing of a method of using an example system.

A method 200 of using an example system includes flow labels and method steps as described herein. In one embodiment, the method steps are performed in an order as described herein. However, in the context of the invention, there is no particular requirement for any such limitation. For example, the method steps can be performed in another order, in a parallel or pipelined manner, or otherwise.

At a step 201, the application 110, such as under control of one or more users 111, issues one or more requests to the ID&A element 121. The ID&A element 121 parses the one or more requests, and determines which portions of those requests can be serviced by the application database 122 without the assistance of any secure information databases 134, and which portions of those requests can be serviced only with the assistance of one or more secure information databases 134.

At a step 202, the ID&A element 121 uses the key 123 to obtain one or more secure connections to information agents 132, where those information agents 132 are associated with one or more secure information databases 134. As part of this step, the ID&A element 121 provides each information agent 132 with the [name of field] information, as described above.

At a step 203, the one or more information agents 132 receive those requests from the ID&A element 121, access the configuration information 133, and respond to the ID&A element 121 with the [name of field, method of access], as described above. As part of this step, the one or more information agents 132 use the [name of field, method of access] to access and manipulate secure information with respect to one or more of the secure information databases 134.

At a step 204, the one or more information agents 132 respond to the ID&A element 121 with responses to any CRUD requests made to access and manipulate secure information with respect to one or more of the secure information databases 134. For example, the one or more information agents 132 can respond to the ID&A element 121 with secure information requested by the application 110.

At a step 205, the ID&A element 121 receives the responses from the one or more information agents 132, possibly including any secure information requested with respect to one or more of the secure information databases 134.

At a step 206, the ID&A element 121 performs those portions of those requests can be serviced by the application database 122 without the assistance of any secure information databases 134.

At a step 207, the ID&A element 121 composes a result from those portions of the requests which were serviced by the application database 122, and those portions of the requests which were serviced with the assistance of one or more secure information databases 134. The ID&A element 121 then responds to the application 110 with the composed results.

The method 200 repeats with the ID&A element 121 receiving and responding to the application 110, or optionally, to more than one such application 110, until a termination trigger is reached.

Secure Access Protocol

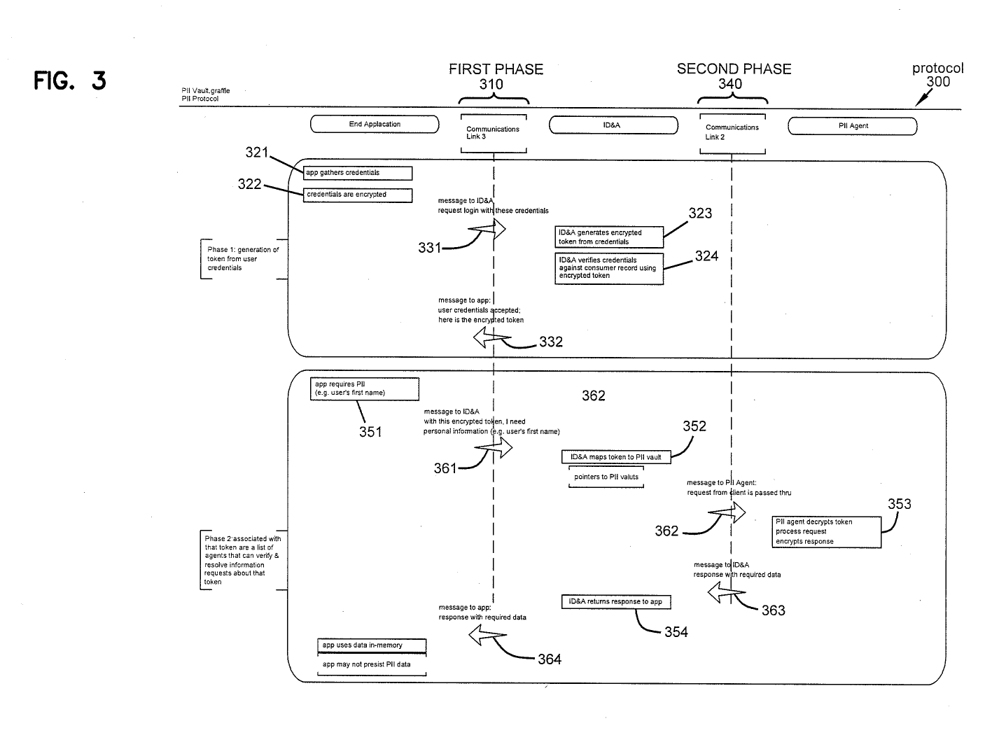

FIG. 3 shows a conceptual drawing of a protocol for accessing a secure information database.

A protocol 300 of using an example system includes active elements, actions, messages, and protocol phases, as described herein. In one embodiment, the active elements can correspond to elements described with respect to the system 100, but in the context of the invention, there is no particular requirement for any such limitation. For example, the active elements can correspond to other elements that perform one or more actions on behalf thereof, such as other devices that might assist or act in lieu of those elements, or otherwise. Similarly, in one embodiment, actions can correspond to method steps described with respect to the method 200, but in the context of the invention, there is no particular requirement for any such limitation. For example, the actions can correspond to other activities that perform one or more functions in addition or instead of those method steps, or otherwise.

In one embodiment, the protocol 300 is performed with respect to an application element, such as the application 110, an ID&A element, such as the ID&A element 121, and an information agent, such as an information agent 132. The application 110 can be coupled to the ID&A element 121 using a first communication link, such as the first communication link 111. Similarly, the ID&A element 121 can be coupled to the information agent 132 using a second communication link, such as the second communication link 124.

In one embodiment, the protocol 300 includes a first phase 310, in which the application 110 communicates with the ID&A element 121, and a second phase 340, in which the ID&A element 1212 communicates with the information agent 132.

The first phase 310 can include an identification and authentication phase, in which the protocol 300 performs an authorization standard. For example, the first phase 310 can include an open standard for authorization (OAUTH) phase, in which users 111 can share private resources maintained by the ID&A element 121 without having to surrender credentials to that ID&A element 121, instead possibly providing usernames and passwords.

The second phase 340 can include an access and utilization phase, in which the protocol 300 can distribute one or more access requests, from users 111, across both non-secure information and secure information. In the second phase 340, the protocol 300 can also combine responses from multiple databases (whether secure information databases 134 or otherwise), and can return a unified response to access requests from users 111.

While this application primarily describes embodiments in which the identification and authentication phase includes a particular authorization standard, in the context of the invention, there is no particular requirement for any such limitation. For example, another authorization standard compatible with the access and utilization phase is within the scope and spirit of the invention, and would be workable without further invention or undue experiment.

FIRST PHASE. At a first phase 310 of the protocol 300, the application 110 communicates with the ID&A element 121.

At an action 321, the application 110 gathers a set of credentials from the user 111.

At an action 322, the application 110 encrypts the credentials for sending to the ID&A element 121. For example, the application 110 can use a secure sockets layer (SSL) protocol, or a variant thereof, to communicate with the ID&A element 121, with the effect that information sent between the application 110 and the ID&A element 121 is maintained confidential between them.

The application 110 sends a login message 331 to the ID&A element 121, including at least some of the credentials from the user 111, with the effect of performing a login by the application 110 to the ID&A element 121.

At an action 323, the ID&A element 121 generates a first encrypted token in response to the login message 313 and the credentials it includes.

At an action 324, the ID&A element 121 verifies the credentials against its record for that user 111.

The ID&A element 121 sends a login-accepted message 332 to the application 110, including at least the first encrypted token.

SECOND PHASE. At a second phase 340 of the protocol 300, the application 110 communicates with the ID&A element 121, which communicates with the information agent 132.

At an action 351, the application 110 determines that it needs at least some personally identifiable information (as shown in the figure, “PII”). For example, the application 110 might determine that it needs the user's full name, or the user's social security number.

The application 110 sends a need-PII message 361 to the ID&A element 121, including at least the first encrypted token and a request for the particular PII the application 110 desires.

At an action 352, the ID&A element 121 performs a mapping between the first encrypted token and a PII vault. In one embodiment, the PII vault includes a database indexed by the first encrypted token, and providing a pointer to one or more locations in that database.

The ID&A element 121 sends a request-PII message 362 to the information agent 132, including at least the request from the application 110 and the first encrypted token.

At an action 353, the information agent 132 decrypts the first encrypted token, processes the request from the application 110, and encrypts a response to the application. As described herein, processing the request from the application 110 can include CRUD actions by the information agent 132, with the effect that the information agent 132 can alter its database of information with respect to the particular user 111. As also described herein, processing the request from the application 110 can also initiate or continue a sequence of actions by the information agent 132, with the effect that the application 110 and the information agent 132 can conduct a multipart sequence of actions.

The information agent 132 sends a response-PII message 363 to the ID&A element 121, including at least the (encrypted) response to the original request by the application 110.

At an action 354, the ID&A element 121 composes an answer to the request by the application 110. As described herein, this action can include activity by the ID&A element 121 to aggregate the answer to the application 110, or otherwise construct an answer to the application 110 in response to more than one information agent 132. For example, the application 110 can request information with respect to a particular user 111, even if that information is distributed across more than one information agent 132. In such cases, as described above, each such information agent 132 composes its own portion of an answer to the application 110, with the effect that the ID&A element 121 composes the aggregated answer to the application 110.

The ID&A element 121 sends an answer-PII message 364 to the application 110, including at least the (encrypted) answer to the original request by the application 110.

In one embodiment, the application 110 does not maintain the PII information with respect to the user 111 in non-secure memory, or send that information to a non-secure recipient, or otherwise persist that information in any way it's security might be compromised. However, there is no guarantee what activity lacking security might be conducted by the user 111.

The protocol 300 repeats with the application 110, the ID&A element 121, and the information agent 132 exchanging messages, with the effect that the application 110 can communicate securely with the information agent 132, until a termination trigger is reached.

Information Flow

FIG. 4 shows a conceptual drawing of information flow in an example system.

In one embodiment, information is coupled between an application 110, a hosted subsystem 120, and a secure subsystem 130. The application 110 couples information and requests between the user 111 and the hosted subsystem 120, using the (hosted subsystem) key 123, sometimes referred to herein as token “T1”. The hosted subsystem 120 couples information and requests between the application 110 and the secure subsystem 130, using the (secure subsystem) key 131, sometimes referred to herein as token “T2”.

An example information flow includes the user 111, a web browser 411, a web portal 412, and a set of communication links and steps providing for information flow. While this application primarily describes one example of information flow, in the context of the invention, there is no particular requirement for following this particular example, and there is no particular requirement for any such limitation or requirement with respect to this particular example.

Obtaining Keys

In one embodiment, the user 111 can communicate with the application 110 using a web browser 411 and a web portal 412. The web browser 411 can include any technique for receiving information from, and for presenting information to, the user 111. For example, the web browser 411 can include a standard web browser 411 such as the “Safari” software from Apple Inc., the “Firefox” open software, and otherwise. For example, the web portal 412 can include a known web address such as “https://redbrickhealth.com/”, served by a web server such as running the “Apache” open source software, and otherwise. In such cases, the user 111 can send commands and requests to the application 110, and the user 111 can send information to, and receive information from, the application 110.

In one embodiment, the user 111 can contact the application 110 by coupling the web browser 411 to a web address identified with a general provider of health information services, and from there can login or otherwise identify their company, employer, or other affinity group. In alternative embodiments, the user 111 can contact the application 110 by coupling the web browser 411 to a web address already identified with their company, employer, or other affinity group. In some alternative embodiments, the web address identified with the user's affinity group can be so identified by encoding it in the URL, such as using a parameter or a subdomain. In some alternative embodiments, the web address can be identified with the particular user 111, and the web portal 412 can identify the user's affinity group using information maintained about the user 111.

Using a communication link 421, the web portal 412 sends information to the application 110. For a first example, the web portal 412 can send a request to authenticate the user 111 to the application 110. For a second example, once the user 111 is authenticated, the web portal 412 can send further information to the application 110, such as commands to alter the user's personally identified information (PII), new information to include with the user's PII, requests for presentation of all or part of the user's PII, and otherwise.

Using a communication link 422, the application 110 sends an authorization request to the hosted subsystem 120, and in particular, to the ID&A element 121 of the hosted subsystem 120. For example, the application 110 can send an authorization request identifying which user 111 is attempting to access the secure subsystem 130.

Using a communication link 423, the ID&A element 121 at the hosted subsystem 120 sends the authorization request to the secure subsystem 130, and in particular, to an authorization server 135 at the secure subsystem 130. For example, the ID&A element 121 can similarly send an authorization request identifying which user 111 is attempting to access the secure subsystem 130.

Using a communication link 423a, the authorization server 135 at the secure subsystem 130 initiates an authentication session with the user 111, using the web browser 411 (or other contact technique by which the user 111 attempted to identify themself). For example, the authorization server 135 can send a message directly to the web browser 411 for presentation to the user 111, such as a message requesting that the user 111 login with a username and password.

Using a communication link 423b, the user 111 presents sufficient credentialing information to the authorization server 135, via the direct connection between the user 111 and the authorization server 135, that the authorization server 135 determines it is confident that the user 111 is the correct person (authentication) and has the authority to issue commands and make requests of the secure subsystem 130 (authorization). For example, the authorization server 135 can request a username and password from the user 111, or the authorization server 135 can use an SSL web security exchange with the web browser 411, or can initiate a multifactor authentication exchange with the user 111, or otherwise. In such cases, the authorization server 135 determines whether or not the user 111 is authenticated as the correct person, and is authorized to make the commands or requests they make.

Using a communication link 424, the authorization server 135 at the secure subsystem 130 sends a key 131, also referred to as a token “T2”, to the ID&A element 121. In one embodiment, the token T2 can be encrypted, obfuscated, or otherwise hidden from packet sniffing, man-in-the-middle, unauthorized listening, or other security attacks. The ID&A element 121 maintains the key 131 (or token T2) at the hosted subsystem 120 and associates that key 131 (or token T2) with the particular user 111.

Using a communication link 425, the ID&A element 121 at the hosted subsystem 120 sends a key 123, also referred to as a token “T1”, to the application 110. In one embodiment, the token T1 can be encrypted, obfuscated, or otherwise hidden from packet sniffing, man-in-the-middle, unauthorized listening, or other security attacks. The application 110 can maintain the key 123 (or token T1) and associate that key 123 (or token T1) with the user 111, or can send the token T1 to the user 111 for safekeeping.

Using a communication link 426, the application 110 sends an “agent hint” to the web portal 412, indicating in response to the information about the user 111, a particular secure subsystem (sometimes referred to herein as a “vault”) that is likely to have the user's PIT associated with any particular command or request from the user 111. The “agent hint” is a convenience that makes it more likely that the user 111 will have their commands and requests responded to more quickly, but is not necessary for operation of the method or system.

In one embodiment, the user's PII might be maintained at more than one secure subsystem 130, or “vault”, with the effect that the user 111 might have to re-obtain authentication and authorization from each such secure subsystem 130 when making commands or requests that affect those particular secure subsystems 130. For a first example, the user 111 might have particular user's PII relating to medical information at more than one medical provider, with the effect that more than one medical provider would server as the secure subsystem 130 for their own particular information. For a second example, the user 111 might have particular user's PIT relating to financial information at more than one financial institution or insurance entity, with the effect that more than one financial institution or insurance entity would server as the secure subsystem 130 for their own particular information. In such cases, the “agent hint” would provide the user 111, or the web browser 411, or the application 110, with information to expedite security concerns when the user 111 makes a command or request that is routed to a secure subsystem 130 that that user 111 has been in contact with already.

Using Keys

Using the communication link 421, the user 111 sends a command, request, or information, as a message “Message (request)”, to the application 110. For example, the user 111 might desire to change their contact information with the secure subsystem 130.

Using the communication link 422, the application 110 identifies the request with the user 111, identifies the associated token T1, encodes the request “request” with the token T1, and sends the message “Message (request, T1)”, to the ID&A element 121 of the hosted subsystem 120. The ID&A element 121 decodes the message, identifies the request “request”, identifies the user's associated token T2, and re-encodes the request as a new message “Message (request, T2)”.

Using the communication link 423, the ID&A element 121 at the hosted subsystem 120 sends the re-encoded message “Message (request, T2)” to the authorization server 135 to the secure subsystem 130.

The authorization server 135 at the secure subsystem 130 decodes the re-encoded message “Message (request, T2)”, determines that the user 111 with token T2 is authorized to make the particular request “request”, and (if so) directs the secure subsystem 130 to services the user's request. The secure subsystem 130 services the user's request, providing a response “response”. The secure subsystem 130 encodes the response with the token T2 as a message “Message (response, T2)”.

Using the communication link 423, the secure subsystem 130 sends the encoded response “Message (response, T2)” to the ID&A element 121 at the hosted subsystem 120. The ID&A element 121 decodes the message, identifies the response “response”, identifies the user's associated token T1, and re-encodes the request as a new message “Message (response, T1)”.

Using the communication link 422, the ID&A element 121 at the hosted subsystem 120 sends the re-encoded response “Message (response, T1)” to the application 110. The application 110 decodes the message and sends the response “response” to the user 111, or alternatively, sends the encoded response to the user 111, who decodes the message and identifies the response “response”.

### ALTERNATIVE EMBODIMENTS

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

1. A method, including steps of
by a server device, receiving a request to manipulate information associated with a user;
determining a first portion of said request which can be performed without access to personal healthcare information and a second portion which involves access to personal healthcare information;
referring said second portion to an information agent, said information agent having access to configuration information providing a method to access said personal healthcare information;
accessing said personal healthcare information in response to said configuration information;
composing an answer to said request to manipulate information, said answer being responsive to said steps of accessing said personal healthcare information and to said first portion of said request.

2. A method as in claim 1,
wherein said steps of accessing said personal healthcare information include steps of
accessing a first portion of said personal healthcare information from a first source, and
accessing a second portion of said personal healthcare information from a second source; and
wherein said steps of composing an answer include steps of
manipulating said first portion of said personal healthcare information,
manipulating said second portion of said personal healthcare information, and
constructing said answer in response to said steps of manipulating said first portion and manipulating said second portion.
